(19) United States
(12) Patent Application Publication
(10) Pub. No.: US 2022/0230064 A1
(43) Pub. Date: Jul. 21, 2022

(54) CALIBRATION OF ANALOG CIRCUITS FOR NEURAL NETWORK COMPUTING

(71) Applicant: MediaTek Singapore Pte. Ltd., Singapore (SG)

(72) Inventors: Po-Heng Chen, Hsinchu (TW); Chia-Da Lee, Hsinchu (TW); Chao-Min Chang, Hsinchu (TW); Chih Chung Cheng, Hsinchu (TW); Hantao Huang, Singapore (SG); Pei-Kuei Tsung, Hsinchu (TW); Chun-Hao Wei, Hsinchu (TW); Ming Yu Chen, Hsinchu (TW)

(21) Appl. No.: 17/569,771

(22) Filed: Jan. 6, 2022

Related U.S. Application Data
(60) Provisional application No. 63/139,463, filed on Jan. 20, 2021.

(51) Int. Cl. G06N 3/08; G06N 3/063; G06F 7/544

(52) U.S. Cl. CPC G06N 3/08; G06F 7/5443; G06N 3/0635

(57) ABSTRACT

An analog circuit is calibrated to perform neural network computing. Calibration input is provided to a pre-trained neural network that includes at least a given layer having pre-trained weights stored in the analog circuit. The analog circuit performs tensor operations of the given layer using the pre-trained weights. Statistics of calibration output from the analog circuit is calculated. Normalization operations to be performed during neural network inference are determined. The normalization operations incorporate the statistics of the calibration output and are performed at a normalization layer that follows the given layer. A configuration of the normalization operations is written into memory while the pre-trained weights stay unchanged.

### CROSS-REFERENCE TO RELATED APPLICATIONS

This application claims the benefit of U.S. Provisional Application No. 63/139,463 filed on Jan. 20, 2021, the entirety of which is incorporated by reference herein.

### TECHNICAL FIELD

Embodiments of the invention relate to analog neural network computing.

### BACKGROUND

A deep neural network (DNN) is a neural network with an input layer, an output layer, and one or more hidden layers between the input layer and the output layer. Each layer performs operations on one or more tensors. A tensor is a mathematical object that can be zero-dimensional (a.k.a. a scaler), one-dimensional (a.k.a. a vector), two-dimensional (a.k.a. a matrix), or multi-dimensional. The operations performed by the layers are numerical computations including, but not limited to: convolution, deconvolution, fully-connected operations, normalization, activation, pooling, resizing, element-wise arithmetic, concatenation, slicing, etc. Some of the layers apply filter weights to a tensor, such as in a convolution operation.

Neural network computing is computation-intensive and often incurs high power consumption. Thus, neural network inference on edge devices needs to be fast and low-power. Well-designed analog circuits, compared to digital circuits, can speed up inference and improve energy efficiency. However, analog computing is more vulnerable to circuit non-idealities, such as process variation, than their digital counterparts. Circuit non-idealities degrades the accuracy of neural network computing. However, it is costly and infeasible to re-train a neural network that suits every manufactured chip. Thus, it is a challenge to improve the accuracy of analog neural network computing.

### SUMMARY

In one embodiment, a method is provided for calibrating an analog circuit to perform neural network computing. According to the method, calibration input is provided to a pre-trained neural network that includes at least a given layer having pre-trained weights stored in the analog circuit. The analog circuit performs tensor operations of the given layer using the pre-trained weight. Statistics of calibration output is calculated from the analog circuit. determining normalization operations to be performed during neural network inference at a normalization layer that follows the given layer, wherein the normalization operations incorporate the statistics of the calibration output; and writing a configuration of the normalization operations into memory while keeping the pre-trained weights unchanged.

In another embodiment, a method of analog circuit calibration is provided for neural network computing. The method comprises the steps of: performing, by the analog circuit, tensor operations on the calibration input using pre-trained weights stored in the analog circuit to generate calibration output of a given layer of a neural network; receiving a configuration of a normalization layer that follows the given layer; and performing neural network inference including the tensor operations of the given layer using the pre-trained weights and normalization operations of the normalization layer. The normalization layer is defined by the normalization operations that incorporate statistics of the calibration output.

In yet another embodiment, a device is provided to perform neural network computing. The device includes an analog circuit to store pre-trained weights of at least a given layer of a neural network. The analog circuit is operative to generate calibration output from the given layer by performing tensor operations on calibration input using the pre-trained weights during calibration; and perform neural network inference including the tensor operations of the given layer using the pre-trained weights. The device also includes a digital circuit to receive a configuration of a normalization layer that follows the given layer; and to perform normalization operations of the normalization layer during the neural network inference. The normalization layer is defined by the normalization operations that incorporate statistics of the calibration output.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating a system operative to perform neural network computing according to one embodiment.

FIG. 2 is a diagram illustrating a mapping between DNN layers and hardware circuits according to one embodiment.

FIG. 3 is a block diagram illustrating an analog circuit according to one embodiment.

FIG. 4 is a flow diagram illustrating a calibration process according to one embodiment.

FIG. 5 illustrates operations performed by a normalization layer according to a first embodiment.

FIG. 6 illustrates operations performed by a normalization layer according to a second embodiment.

FIG. 7 is a flow diagram illustrating a method for calibrating an analog circuit for neural network computing according to one embodiment.

FIG. 8 is a flow diagram illustrating a method of analog circuit calibration for neural network computing according to another embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a device and methods for calibrating an analog circuit to improve the accuracy of analog neural network computations. The device may include both an analog circuit and a digital circuit for performing neural network computations according to a deep neural network (DNN) model. The DNN model includes a first set of layers (“A-layers”) mapped to the analog circuit and a second set of layers (“D-layers”) mapped to the digital circuit. Each layer is defined by corresponding operations. For example, a convolution layer is defined by corresponding filter weights and parameters for performing the convolution. The DNN model is pre-trained before loading onto devices. However, analog circuits fabricated on different chips may have different non-ideal characteristics. Thus, the same set of pre-trained filter weights and parameters may cause different analog circuits to generate different outputs. The calibration described herein removes or reduces the variations across different chips.

The calibration is performed offline after DNN training on the output of each A-layer. During the calibration process, calibration input is fed into the DNN and the statistics of the calibration output of each A-layer is collected. The calibration input may be a subset of the training data used for the DNN training. The calibration is different from re-training because the parameters and weights learned in the training remain unchanged during and after the calibration.

In some embodiments, the statistics of each A-layer's calibration output are used to modify or replace some of the operations defined in the DNN model. The statistics may be used to modify a batch normalization (BN) layer that is located immediately after an A-layer in the DNN model. Alternatively, the statistics may be used to define a set of multiply-and-add operations that apply to the output of an A-layer. In the following description, the term “normalization layer” refers to the layer that is located immediately after an A-layer and applies normalization operations to the output of the A-layer. The normalization operations are determined based on the statistics of the calibration output of the A-layer. After the calibration and the configuration of normalization layers, the device carries out inference according to the calibrated DNN model that includes the normalization layers.

In one embodiment, the tensor operations performed by the A-layers and the D-layers may be convolution operations. The convolutions performed by an A-layer and a D-layer may be the same or different types of convolutions. For example, an A-layer may perform normal convolutions and a D-layer may perform depth-wise convolutions or vice versa. The channel dimension is the same as the depth dimension. Suppose that a convolution layer receives an input tensor of M channels and produces an output tensor of N channels, where M and N may be the same number or different numbers. In a “normal convolution” where N filters are used, each filter convolves with M channels of the input tensor to produce M outputs. The M outputs are summed up to generate one of the N channels of the output tensor. In a “depth-wise convolution,” M=N and there is a one-to-one correspondence between M filters used in the convolution and the M channels of the input tensor, where each filter convolves with one channel of the input tensor to produce one channel of the output tensor.

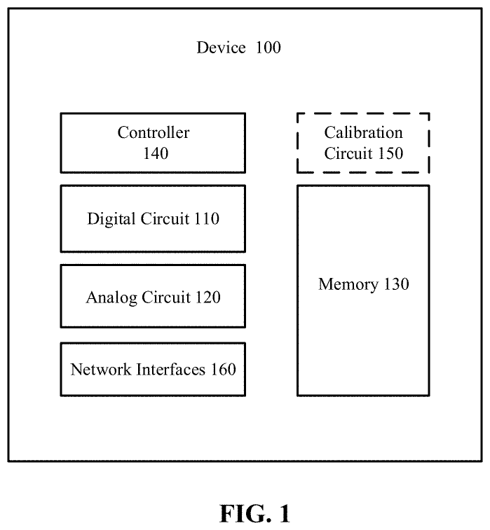

FIG. 1 is a block diagram illustrating a device 100 operative to perform neural network computing according to one embodiment. The device 100 includes one or more general-purpose and/or special-purpose digital circuits 110 such as central processing units (CPUs), graphics processing units (GPUs), digital processing units (DSPs), field-programmable gate arrays (FPGAs), neural processing units (NPUs), arithmetic and logic units (ALUs), application-specific integrated circuit (ASIC), and other digital circuitry. The device 100 also includes one or more analog circuits 120 that perform mathematical operations; e.g., tensor operations. In one embodiment, the analog circuit 120 may be an analog compute-in-memory (ACIM) device, which includes a cell array that has storage and embedded computation capabilities. For example, the cell array of an ACIM device may store the filter weights of a convolution layer. When input data arrives at the cell array, the cell array performs convolution by producing output voltage levels corresponding to the convolution of the filter weights and the input data.

In one embodiment, the digital circuit 110 is coupled to a memory 130, which may include memory devices such as dynamic random-access memory (DRAM), static random access memory (SRAM), flash memory, and other non-transitory machine-readable storage media; e.g., volatile or non-volatile memory devices. To simplify the illustration, the memory 130 is represented as one block; however, it is understood that the memory 130 may represent a hierarchy of memory components such as cache memory, system memory, solid-state or magnetic storage devices, etc. The digital circuit 110 executes instructions stored in the memory 130 to perform operations such as tensor operations and normalization operations for one or more neural network layers.

In one embodiment, the device 100 also includes a controller 140 to schedule and assign operations defined in a DNN model to the digital circuit 110 and the analog circuit 120. In one embodiment, the controller 140 may be part of the digital circuit 110. In one embodiment, the device 100 also includes a calibration circuit 150 for performing calibration of the analog circuit 120. The calibration circuit 150 is illustrated in dashed outlines to show it may be located in an alternative location. The calibration circuit 150 may be on the same chip as the analog circuit 120; alternatively, the calibration circuit 150 may be on a different chip from the analog circuit 120, but in the same device 100. In yet another embodiment, the calibration circuit 150 may be in another system or device, such as a computer or a server.

The device 100 may also include a network interface 160 for communicating with another system or device via a wired and/or wireless network. It is understood that the device 100 may include additional components not shown in FIG. 1 for simplicity of illustration. In one embodiment, the digital circuit 110 may execute instructions stored in the memory 130 to perform operations of the controller 140 and/or the calibration circuit 150.

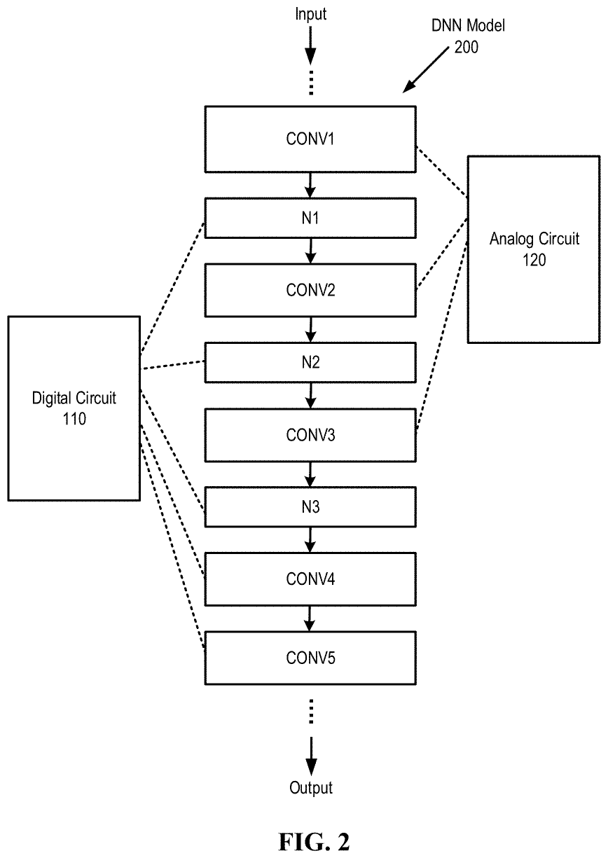

FIG. 2 is a diagram illustrating a mapping between a DNN model 200 and hardware circuits according to one embodiment. The term “mapping” refers to the assignment of tensor operations defined in the DNN model to hardware circuits that perform the operations. In this example, the DNN model includes, among others, multiple convolution layers (e.g., CONV1-CONV5). Referring also to FIG. 1, operations of CONV1, CONV2, and CONV3 (“A-layers”) may be assigned to the analog circuit 120, and operations of CONV4 and CONV5 (“D-layers”) may be assigned to the digital circuit 110. The assignment of a convolution layer to either the analog circuit 120 or the digital circuit 110 may be guided by criteria such as computation complexity, power consumption, accuracy requirements, etc. The filter weights of CONV1, CONV2, and CONV3 are stored in the analog circuit 120, and the filter weights of CONV3 and CONV3 are stored in a memory device (e.g., the memory 130 in FIG. 1) accessible by the digital circuit 110. The DNN model 200 may include additional layers (e.g., pooling, ReLU, etc.), which are omitted from FIG. 2 to simplify the illustration.

The DNN model 200 in FIG. 2 is a calibrated DNN; that is, it includes normalization layers (N1, N2, and N3) produced by calibration. Each normalization layer is placed at the output of a corresponding A-layer. In a first embodiment, a normalization layer may be a modified BN layer modified by the statistics of calibration output from the preceding A-layer. In a second embodiment, a normalization layer may apply depth-wise convolutions to the output of the preceding A-layer, where the filter weights are obtained at least in part from the statistics of calibration output from the preceding A-layer. The filter weights associated with CONV1-CONV5 learned from the training are stored in the device 100 (e.g., the analog circuit 120 and the memory 130), and they do not change during and after the calibration.

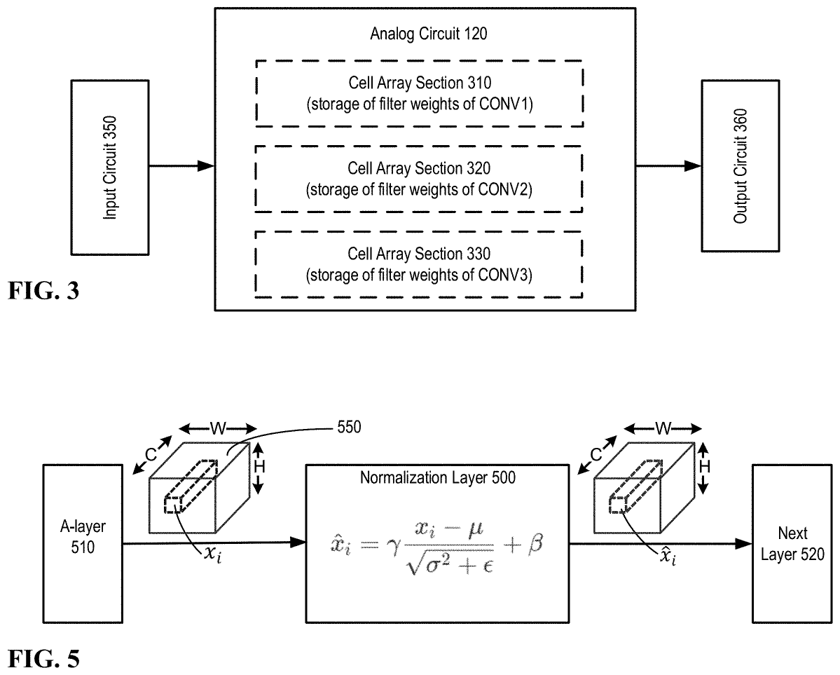

FIG. 3 is a block diagram illustrating the analog circuit 120 according to one embodiment. The analog circuit 120 may be an ACIM device that includes a cell array for data storage and in-memory computations. Various designs and implementations of ACIM devices exist; it is understood that the analog circuit 120 is not limited to a particular type of ACIM device. In this example, the cell array of the analog circuit 120 includes multiple cell array sections (e.g., 310, 320, and 330) that store filter weights of convolution layers CONV1, CONV2, and CONV3, respectively. The analog circuit 120 is coupled to an input circuit 350 and an output circuit 360, which buffer input data and output data of convolution operations, respectively. The input circuit 350 and the output circuit 360 may also include a conversion circuit for converting between analog and digital data formats.

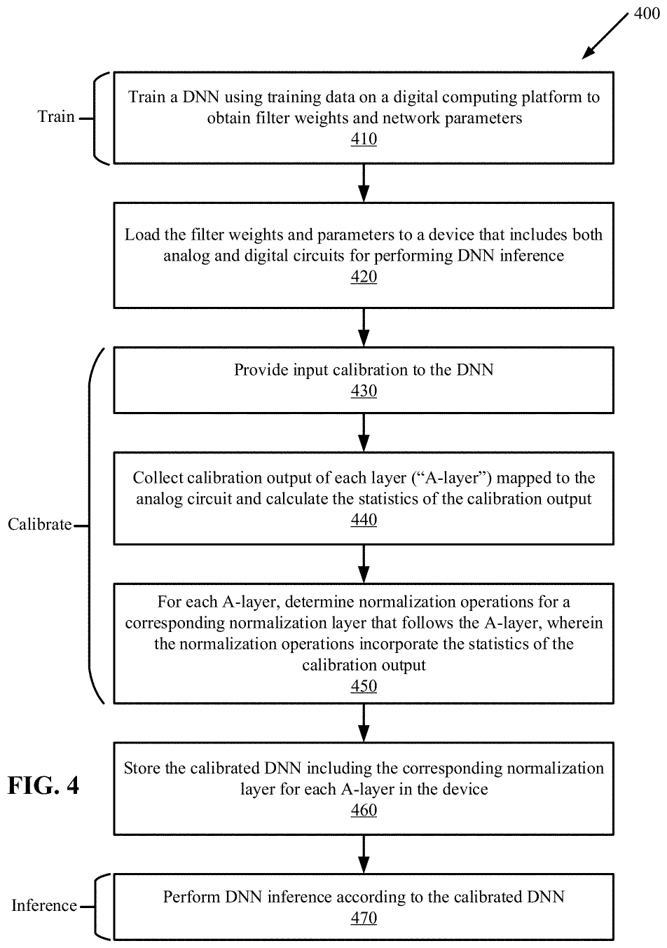

FIG. 4 is a flow diagram illustrating a calibration process 400 according to one embodiment. The calibration process 400 begins at a training step 410 when a DNN (e.g., the DNN model 200 in FIG. 2) is trained using a set of training data by digital circuits; e.g., CPUs in a computer, or the like. The training produces filter weights for convolutions and parameters for batch normalization (e.g., β and γ). The value ε is used to avoid dividing by a zero value. Training methods for convolution and batch normalization are known in the field of neural network computing. At step 420, the filter weights and parameters are loaded to a device (e.g., the device 100 in FIG. 1) that includes both analog and digital circuits for performing DNN inference. A first set of filter weights are stored in a memory accessible to the digital circuit and a second set of filter weights are stored in the analog circuit. Steps 430-450 are calibration steps. At step 430, calibration input is provided to the DNN, which at this point is trained and uncalibrated. In one embodiment, the calibration input may be a subset of the training data used at step 410. At step 440, the calibration output of each A-layer is collected, and the statistics of the calibration output are collected and calculated. In one embodiment, the statistics may include the mean value and/or the standard deviation of the calibration output. The statistics (e.g., mean and/or standard deviation) may be calculated for each calibration output activation including all dimensions (i.e., height, width, and depth). Alternatively, the statistics may be calculated depth-wise (i.e., per-channel) for each calibration output activation across the height and width dimensions.

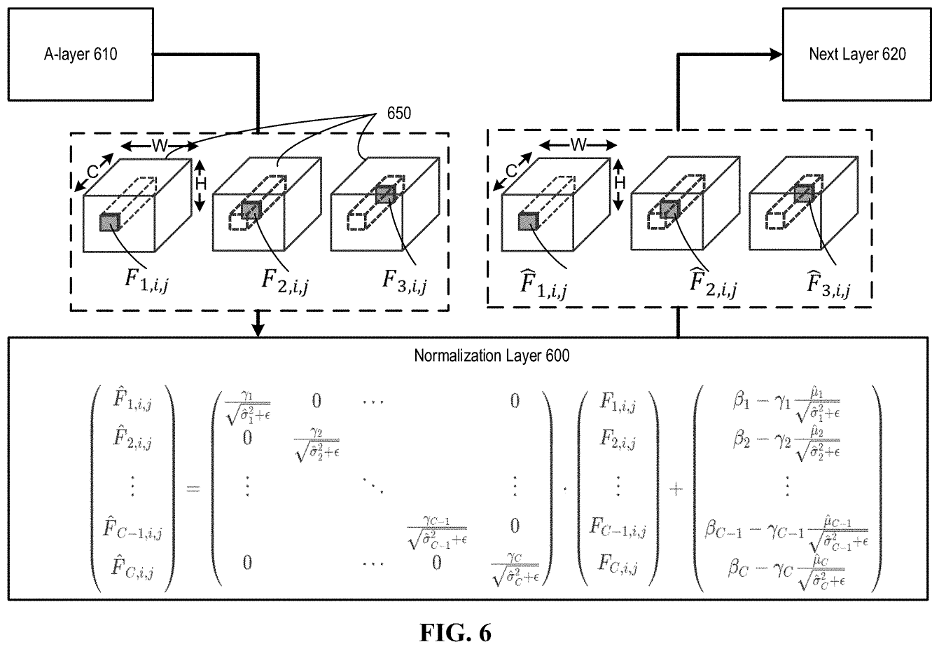

The calculation of the statistics may be performed by an on-chip processor or circuit; alternatively, the calculation may be performed by off-chip hardware or another device such as a computer or server. At step 450 for each A-layer, the statistics are incorporated into normalization operations that define a normalization layer following the A-layer in the DNN. Non-limiting examples of the normalization operations will be provided with reference to FIGS. 5 and 6. A DNN that includes the normalization layers determined at step 450 is referred to as a calibrated DNN. At step 460, the calibrated DNN is stored in the device, where the calibrated DNN includes a corresponding normalization layer for each A-layer. At inference step 470, the device performs neural network inference according to the calibrated DNN. The filter weights obtained from training at step 410 remain unchanged and are used for neural network inference.

FIG. 5 illustrates a normalization layer 500 according to a first embodiment. Referring also to the example in FIG. 2, the normalization layer 500 may be any one of N1, N2, and N3. The normalization layer 500 may be a modified BN layer. In a trained DNN, an unmodified BN layer is located immediately after an A-layer 510 (e.g., any one of CONV1, CONV2, and CONV3). During training, the parameters of the unmodified BN layer (e.g., β, γ, and ε) are learned. After the trained DNN is loaded to the device 100 (FIG. 1), the calibration process 400 (FIG. 4) is performed to calibrate the layers mapped to the analog circuit 120 including the A-layer 510.

The normalization layer 500 is defined by normalization operations that apply to a tensor (represented by a cube 550 in solid outlines) output from the A-layer 510. During calibration, this tensor is referred to as the calibration output or calibration output activation. The tensor has a height dimension (H), a width dimension (W), and a depth dimension (C) that is also referred to as a channel dimension. The normalization operations transform each xᵢ (represented by an elongated cube in dashed outlines) into \hat{x}ᵢ. Both xᵢ and \hat{x}ᵢ extend across the entire depth dimension C. In the example of FIG. 5, the normalization layer 500 incorporates both the mean value μ and the standard deviation σ into the normalization operations. In another embodiment, the normalization layer 500 may incorporate one of μ and σ into the normalization operations. The mean value μ and the standard deviation σ are calculated from the calibration output of the A-layer 510 that includes data points across all dimensions (H, W, and C). In addition, the normalization layer 500 also incorporates the parameters of the unmodified BN layer (e.g., β and γ) learned in the training. Thus, the normalization layer 500 is also referred to as the modified BN layer, which is modified to incorporate at least the mean value μ calculated across all dimensions of the calibration output.

FIG. 6 illustrates operations performed by a normalization layer 600 according to a second embodiment. Referring also to the example in FIG. 2, the normalization layer 600 may be any one of N1, N2, and N3. The normalization layer 600 may be a replacement for a BN layer that is located immediately after an A-layer 610 (e.g., any one of CONV1, CONV2, and CONV3) in the uncalibrated DNN. During training, the depth-wise parameters (e.g., βₖ, γₖ, and ε) for each channel across the depth dimension are learned, where the running index k identifies a specific channel. After the trained DNN is loaded to the device 100 (FIG. 1), the calibration process 400 (FIG. 4) is performed to calibrate the layers mapped to the analog circuit 120 including the A-layer 610.

The normalization layer 600 is defined by normalization operations that apply to a tensor (represented by each cube 650 in solid outlines) output from the A-layer 510. During calibration, this tensor is referred to as the calibration output or calibration output activation. The tensor has a height dimension (H), a width dimension (W), and a depth dimension (C) that is also referred to as a channel dimension. The normalization operations transform each F_{k,i,j} (represented by one slice of an elongated cube in dashed outlines) into \hat{F}_{k,i,j}, where the running index k identifies a specific channel. Both F_{k,i,j} and \hat{F}_{k,i,j} are per-channel tensors. In the example of FIG. 6, the normalization layer 600 incorporates both the per-channel mean value \hat{μ}ₖ and the per-channel standard deviation \hat{σ}ₖ into the normalization operations. In another embodiment, the normalization layer 600 may incorporate one of the per-channel mean and the per-channel standard deviation into the normalization operations. The per-channel mean and the per-channel standard deviation are calculated from the calibration output of the A-layer 610 across both H and W dimensions for each channel in the C dimension. In addition, the normalization layer 500 also incorporates the depth-wise parameters (e.g., βₖ, γₖ, and ε) learned in the training. As illustrated in FIG. 6, the normalization operations include depth-wise multiply-and-add operations that incorporate at least the depth-wise (i.e., per-channel) mean value calculated from each channel of the calibration output. As the multiplication matrix shown in the normalization layer 600 is a diagonal matrix, the depth-wise multiply-and-add operations in this example are also referred to as a 1×1 depth-wise convolution operation.

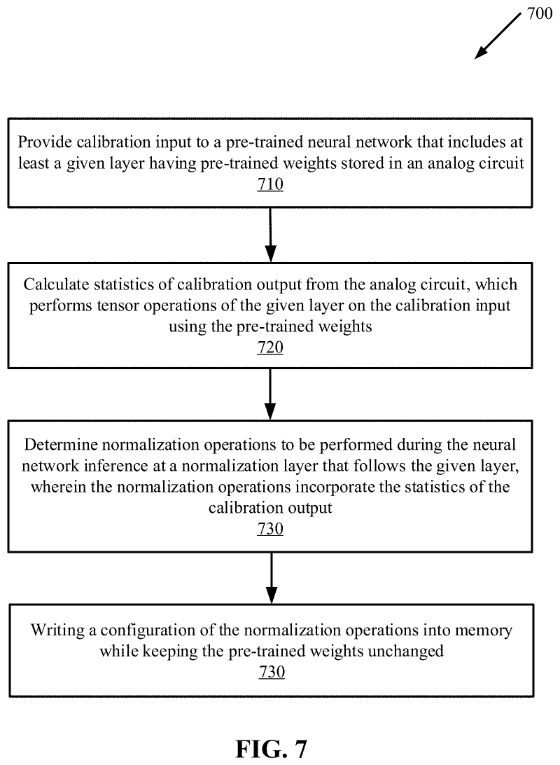

FIG. 7 is a flow diagram illustrating a method 700 for calibrating an analog circuit to perform neural network computing according to one embodiment. The method 700 may be performed by a calibration circuit (e.g., the calibration circuit 150 of FIG. 1), which may be on the same chip as the analog circuit, on a different chip or in a different device from where the analog circuit is located.

The method 700 begins at step 710 when a calibration circuit sends calibration input to a pre-trained neural network that includes at least a given layer having pre-trained weights stored in the analog circuit. At step 720, the calibration circuit calculates statistics of calibration output from the analog circuit, which performs tensor operations of the given layer on the calibration input using the pre-trained weights. At step 730, the calibration circuit determines normalization operations to be performed during neural network inference at a normalization layer that follows the given layer. The normalization operations incorporate the statistics of the calibration output. At step 740, the calibration circuit writes a configuration of the normalization operations into memory. The pre-trained weights remain unchanged after the calibration.

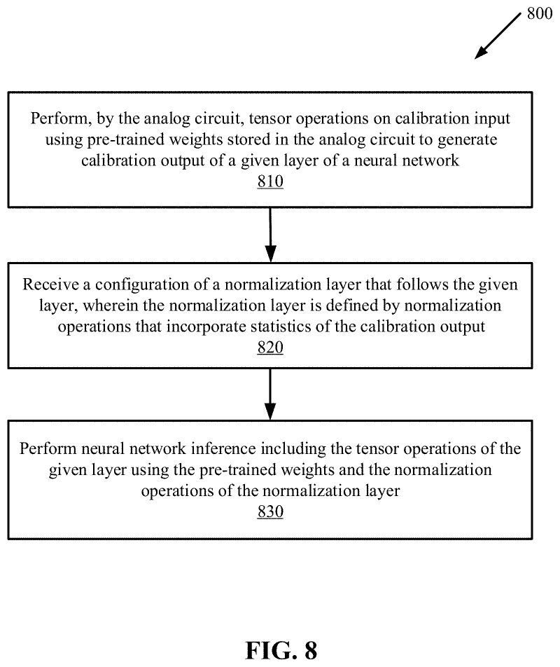

FIG. 8 is a flow diagram illustrating a method 800 of analog circuit calibration for neural network computing according to one embodiment. The method 800 may be performed by a device that includes an analog circuit for neural network computing; e.g., the device 100 of FIG. 1.

The method 800 begins at step 810 when the analog circuit performs tensor operations on calibration input using pre-trained weights that are stored in the analog circuit. By performing the tensor operations, the analog circuit generates calibration output of a given layer of a neural network. At step 820, the device receives a configuration of a normalization layer that follows the given layer. The normalization layer is defined by normalization operations that incorporate statistics of the calibration output. At step 830, the device performs neural network inference including the tensor operations of the given layer using the pre-trained weights and the normalization operations of the normalization layer.

In one embodiment, during the neural network inference, the analog circuit is assigned to perform the tensor operations of the given layer using the pre-trained weights, and a digital circuit in the device is assigned to perform the normalization operations of the normalization layer.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

The operations of the flow diagrams of FIGS. 4, 7, and 8 have been described with reference to the exemplary embodiment of FIG. 1. However, it should be understood that the operations of the flow diagrams of FIGS. 4, 7, and 8 can be performed by embodiments of the invention other than the embodiment of FIG. 1, and the embodiment of FIG. 1 can perform operations different than those discussed with reference to the flow diagrams. While the flow diagrams of FIGS. 4, 7, and 8 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for calibrating an analog circuit to perform neural network computing, comprising:
providing calibration input to a pre-trained neural network that includes at least a given layer having pre-trained weights stored in the analog circuit;
calculating statistics of calibration output from the analog circuit, which performs tensor operations of the given layer using the pre-trained weights;
determining normalization operations to be performed during neural network inference at a normalization layer that follows the given layer, wherein the normalization operations incorporate the statistics of the calibration output; and
writing a configuration of the normalization operations into memory while keeping the pre-trained weights unchanged.

2. The method of claim 1, wherein the analog circuit is an analog compute-in-memory (ACIM) device.

3. The method of claim 1, wherein calculating the statistics further comprising:
calculating the statistics to include at least one of a standard deviation and a mean value of the calibration output.

4. The method of claim 1, wherein the calibration output has a height dimension, a width dimension, and a depth dimension, and collecting the statistics further comprises:
calculating the statistics to include a mean value across all dimensions of the calibration output.

5. The method of claim 4, wherein the normalization layer is a batch normalization modified to incorporate at least the mean value.

6. The method of claim 1, wherein the calibration output has a height dimension, a width dimension, and a depth dimension, and collecting the statistics further comprises:
calculating the statistics to include a depth-wise mean value of the calibration output for each of a plurality of channels in the depth dimension.

7. The method of claim 6, wherein the normalization operations include depth-wise multiply-and-add operations that incorporate at least the depth-wise mean value for each channel.

8. The method of claim 1, wherein the calibrating of the analog circuit is performed on a same chip as the analog circuit.

9. The method of claim 1, wherein the calibrating of the analog circuit is performed on a different chip or a different device from where the analog circuit is located.

10. A method of analog circuit calibration for neural network computing, comprising:
performing, by the analog circuit, tensor operations on calibration input using pre-trained weights stored in the analog circuit to generate calibration output of a given layer of a neural network;
receiving a configuration of a normalization layer that follows the given layer, wherein the normalization layer is defined by normalization operations that incorporate statistics of the calibration output; and
performing neural network inference including the tensor operations of the given layer using the pre-trained weights and the normalization operations of the normalization layer.

11. The method of claim 10, wherein the analog circuit is an analog compute-in-memory (ACIM) device.

12. The method of claim 10, wherein the statistics includes at least one of a standard deviation and a mean value of the calibration output.

13. The method of claim 10, wherein the normalization layer is a batch normalization modified to incorporate at least a mean value calculated across all dimensions of the calibration output.

14. The method of claim 10, wherein the normalization operations include depth-wise multiply-and-add operations that incorporate at least a depth-wise mean value calculated from each of a plurality of channels of the calibration output.

15. The method of claim 10, further comprising:
assigning the tensor operations of the given layer to the analog circuit for execution; and
assigning the normalization operations of the normalization layer to a digital circuit for execution during the neural network inference.

16. A device operable to perform neural network computing, comprising:
an analog circuit to store pre-trained weights of at least a given layer of a neural network, wherein the analog circuit is operative to:
generate calibration output from the given layer by performing tensor operations on calibration input using the pre-trained weights during calibration; and
perform neural network inference including the tensor operations of the given layer using the pre-trained weights; and
a digital circuit to receive a configuration of a normalization layer that follows the given layer, wherein the normalization layer is defined by normalization operations that incorporate statistics of the calibration output, and to perform the normalization operations of the normalization layer during the neural network inference.

17. The device of claim 16, wherein the analog circuit is an analog compute-in-memory (ACIM) device.

18. The device of claim 16, wherein the statistics includes at least one of a standard deviation and a mean value of the calibration output.

19. The device of claim 16, wherein the normalization layer is a batch normalization modified to incorporate at least a mean value calculated across all dimensions of the calibration output.

20. The device of claim 16, wherein the normalization operations include depth-wise multiply-and-add operations that incorporate at least a depth-wise mean value calculated from each of a plurality of channels of the calibration output.
